(19) United States
(12) Patent Application Publication
(10) Pub. No.: US 2018/0086452 A1
(43) Pub. Date: Mar. 29, 2018

(54) DRONE-CARRIER BROKERING

(71) Applicant: Intel Corporation, Santa Clara, CA (US)

(72) Inventors: Simon Hunt, Naples, FL (US); Neeta Srivastava, San Jose, CA (US)

(73) Assignee: Intel Corporation, Santa Clara, CA (US)

(21) Appl. No.: 15/279,133

(22) Filed: Sep. 28, 2016

(51) Int. Cl. B64C 39/02; G06Q 10/08

(52) U.S. Cl. CPC B64C 39/024; G06Q 10/0835

(57) ABSTRACT

In an example, there is disclosed a drone operator computing apparatus having: a network interface; and one or more logic elements providing a broker agent to: communicatively couple to a drone brokerage engine via the network interface; send a carrier request comprising a request for a carrier to carry a drone through a prohibitive zone; receive a brokered carrier response comprising an engage point; and dispatch the drone to the engage point. There is also disclosed a drone having a navigation engine to proceed to the engage point and engage a carrier. There is also disclosed a brokerage engine to broker a carrier request from the drone operator, receive a carrier response from a carrier operator, and broker the carrier response.

### FIELD OF THE SPECIFICATION

This disclosure relates in general to the field of transportation, and more particularly, though not exclusively to, a system and method for drone-carrier brokering.

### BACKGROUND

Drones are remote-controlled, autonomous, or semi-autonomous vehicles that can be used to carry out functions such as surveillance, delivery, or recreation, to name just a few. A popular drone is the “quad copter,” which has four propellers for stability, and which comes in many different varieties.

### BRIEF DESCRIPTION OF THE DRAWINGS

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

FIG. 1 is a block diagram of a drone-carrier brokerage ecosystem.

FIG. 2 is a block diagram of a client device according to one or more examples of the present specification.

FIG. 3 is a block diagram of a broker device according to one or more examples of the present specification.

FIG. 4 is a block diagram of a drone according to one or more example of the present specification.

FIG. 5 is a diagram of drone passage through a prohibitive zone according to one or more examples of the present specification.

FIG. 6 is a signal flow diagram according to one or more examples of the present specification.

FIG. 7 is a flow chart of a drone operator method according to one or more examples of the present specification.

FIG. 8 is a flow chart of a brokerage method according to one or more examples of the present specification.

FIG. 9 is a flow chart of a carrier method according to one or more examples of the present specification.

### SUMMARY

In an example, there is disclosed a drone operator computing apparatus having: a network interface; and one or more logic elements providing a broker agent to: communicatively couple to a drone brokerage engine via the network interface; send a carrier request comprising a request for a carrier to carry a drone through a prohibitive zone; receive a brokered carrier response comprising an engage point; and dispatch the drone to the engage point. There is also disclosed a drone having a navigation engine to proceed to the engage point and engage a carrier. There is also disclosed a brokerage engine to broker a carrier request from the drone operator, receive a carrier response from a carrier operator, and broker the carrier response

### Embodiments of the Disclosure

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

As used throughout this specification, a “drone” includes any unmanned vehicle of any type, including by way of nonlimiting example, fixed-wing unmanned aerial vehicles (UAVs), rotary-wing UAVs, hobbyist UAVs, unmanned submersibles, unmanned watercraft, unmanned wheeled or tracked vehicles, unmanned downhole vehicles or tools for use in drilling, unmanned exploration and excavation vehicles, microelectromechanical systems (MEMS), and unmanned probes and sensors. Drones may be of any size or variety, and may include any type of impeller or other locomotion apparatus. A “carrier” is any vehicle, manned or unmanned, that is capable of engaging with and carrying a drone. Carriers may be of any size or configuration. Different types of carriers may be better adapted to carrying different types of drones.

In the quest to be ever more responsive to immediate customer demands, providers of goods and services constantly seek new ways to deliver to customers what they want when they want it. In the case of digital media, the solution is to deliver the media over high-bandwidth network connections. But in the case of physical goods, absent a Star Trek-style transporter beam, goods must be moved physically from one location to another. One solution that is becoming increasingly popular is delivering goods via autonomous or semiautonomous drones. For example, a user orders an item online, and requests expedited delivery, usually for an additional fee. That expedited delivery may include the option of delivery via drone, such as a quad copter that lifts the package and flies it to the user's location. The drone then gently lowers the package onto the user's porch and returns to its starting location.

While this model provides great flexibility and responsiveness to users' demands for instant gratification, it does have limitations. In the first place, drones have limited cargo capacity and range. The range may decrease as the size and mass of the payload increases. Furthermore, drones may find that there are zones that are prohibitive to them. A prohibitive zone is any zone where it is impractical or even illegal for the drone to fly. A prohibitive zone may be delineated many different factors. For example, one prohibitive zone may include a long stretch that is simply out of range for the drone. Another prohibitive zone may include a no-fly zone where it is illegal for the drone to operate. Yet another prohibitive zone may be a bridge where it is impractical or illegal for the drone to navigate. Yet another prohibitive zone may include a crowded metropolitan area, where navigation obstacles make it impractical for the drone to navigate. Yet another example of a prohibitive zone is a zone where it is unsafe for drones to operate (even if it legal and otherwise practical for the drone), such as areas experiencing strong weather patterns, strong electrical magnetic or electrical fields that may interfere with navigation, or where irritable land owners are liable to simply shoot drones out of the sky.

Providing safe and legal passage through prohibitive zones not only increases the drone's range, but also makes it possible for the drone to go places it could not otherwise go. For example, if goods are to be delivered to a medium-security corporate or government facility, the facility itself may be a no-fly zone that a drone may not enter. However, the drone may be permitted to “hitch” a ride on top of a truck that is entering the facility. This should not be understood to be a covert infiltration, but rather may be overtly facilitated by a brokering service that allows the drone operator to negotiate an exchange of consideration for allowing the drone to use the truck as a carrier. Such a brokerage service may allow many different types of drones to negotiate passage through many different types of prohibitive zones on many different types of carrier vehicles, thus greatly extending the reach and utility of the drones.

However this example also illustrates challenges that accompany a drone-carrier brokerage service. For example, the medium-security facility may not find it acceptable to simply allow random drones to land on trucks and enter the base. A drone that can deliver a pizza may just as easily deliver a bomb, biological weapon, or some other dangerous payload. Thus, security mechanisms may need to be in place to allow the drone and its payload to be screened or authenticated before deeming the drone safe to use a vehicle as a carrier. Depending on the security context, this may include onboard screening of the drone from the carrier vehicle, or it may be sufficient to ensure that the drone is operated by a carrier with a sufficient reputation for safe deliveries. In this context, the drone may be treated analogous to a network object. As a drone operator operates drones, its drones and payloads may initially be subject to greater scrutiny as the drone operator establishes a reputation. But over time, as the drone operator proves to have reliable safeguards in place and is known to deliver safe payloads, its reputation may increase until it is permitted to request a carrier with less initial screening.

A drone-carrier brokerage service may also provide advantages to the carrier. For example, a carrier may engage a drone with little to no extra effort on its part, and may thus receive additional remuneration for traversing a route that it was already going to traverse anyway. To this end, some carriers may publish their routes to the drone-carrier brokerage, thus allowing the brokerage engine to select an appropriate carrier, and allowing drone operators to plan ahead for when to best request a carrier to traverse a particular prohibitive zone.

A carrier operator may include any entity that operates a carrier vehicle, such as a taxi service, a ride share service (such as Uber or Lyft), a bus line, a train, an airline, a shipping line, a navy or other military branch, or any other operator of vehicles willing to provide carrier services to drones.

A system and method for drone-carrier brokering will now be described with more particular reference to the attached FIGURES. It should be noted that throughout the FIGURES, certain reference numerals may be repeated to indicate that a particular device or block is wholly or substantially consistent across the FIGURES. This is not, however, intended to imply any particular relationship between the various embodiments disclosed. In certain examples, a genus of elements may be referred to by a particular reference numeral (“widget 10”), while individual species or examples of the genus may be referred to by a hyphenated numeral (“first specific widget 10-1” and “second specific widget 10-2”).

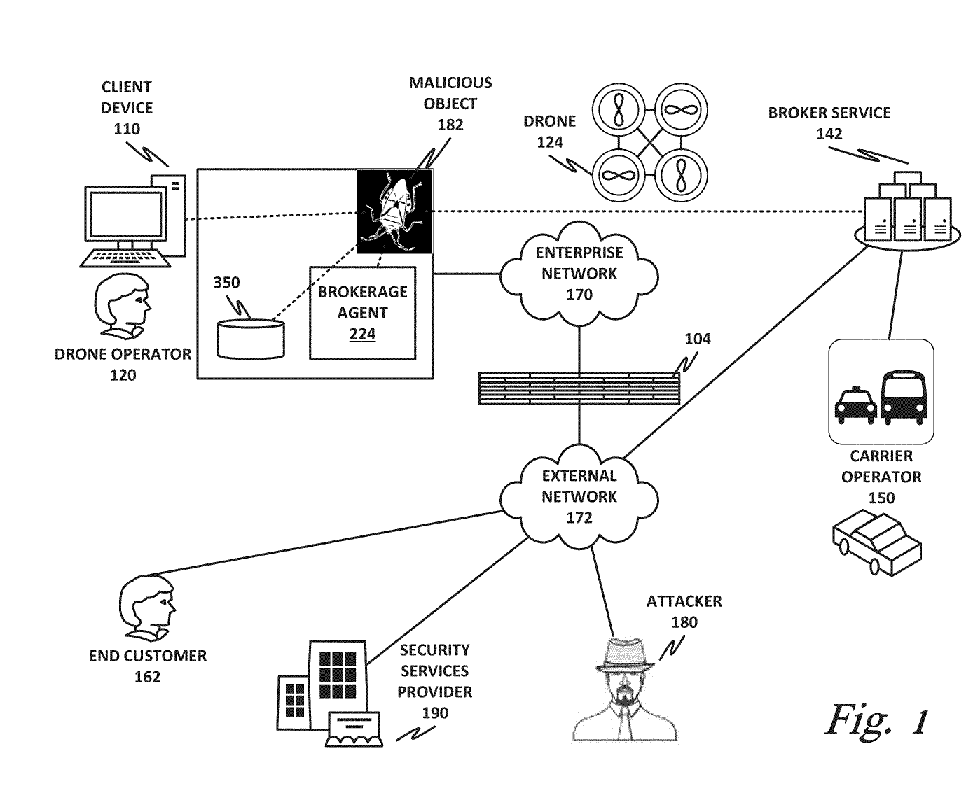

FIG. 1 is a network-level diagram of a drone-carrier brokerage ecosystem according to one or more examples of the present specification. In the example of FIG. 1, a drone operator 120 operating a drone 124, and a carrier operator 150 operating a carrier 152 both interact with a broker service 142 to broker drone-carrier exchanges as described herein.

Drone operator 120 may be an enterprise, such as an online retailer that provides delivery of goods to consumers via drone 124. In some cases, drone operator 120 is not the retailer itself, but rather may be an independent contractor that contracts with the retail entity to operate drone 124 to deliver goods to customer 162. Note that delivery of goods is provided in this specification as a nonlimiting example, but the scope of this specification is intended to encompass any use of drone 124.

In an example, customer 162 operates a personal computing device via external network 172, and accesses servers of drone operator 120 to order a product. Optionally for a premium delivery fee, customer 162 may request immediate or near-immediate delivery via drone 124.

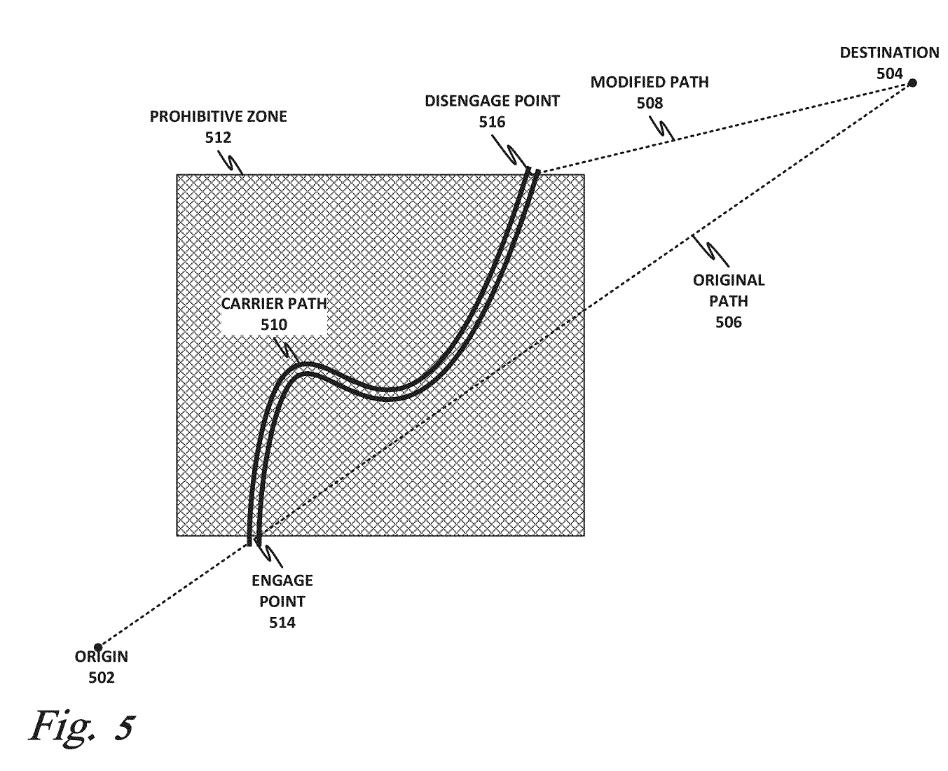

Drone operator 120 operates brokerage agent 224 of client device 110. Brokerage agent 224 communicates with broker service 142 to negotiate a carrier, such as carrier 152 provided by carrier operator 150. For example, customer 162 may be located far enough away from drone operator 120 that drone 124 is out of drone 124's operational range. Thus drone operator 120 negotiates via broker service 142 with carrier operator 150 to arrange for carrier 152 to carry drone 124 through a prohibitive zone 512 (FIG. 5) so that drone 124 can successfully deliver the product to customer 162.

In some embodiments, attacker 180 may try to interfere with or modify this process, such as by inserting malicious object 182 into client device 110 to interfere with brokerage agent 224 or with storage 350, or with the intent that malicious object 182 propagate to drone 124 and upset its navigation functions. Thus, drone operator 120, carrier operator 150, or broker service 142 may contract with security services provider 190 to provide security mechanisms that will prevent attacker 180 from successfully inserting malicious object 182.

Within the enterprise of drone operator 120, client devices 110 may be communicatively coupled to one another and to other network resources via enterprise network 170. Enterprise network 170 may be any suitable network or combination of one or more networks operating on one or more suitable networking protocols, including for example, a local area network, an intranet, a virtual network, a wide area network, a wireless network, a cellular network, or the Internet (optionally accessed via a proxy, virtual machine, or other similar security mechanism) by way of nonlimiting example. Enterprise network 170 may also include one or more servers, firewalls, routers, switches, security appliances, antivirus servers, or other useful network devices, which in an example may be virtualized within workload cluster 142. In this illustration, enterprise network 170 is shown as a single network for simplicity, but in some embodiments, enterprise network 170 may include a large number of networks, such as one or more enterprise intranets connected to the internet. Enterprise network 170 may also provide access to an external network, such as the Internet, via external network 172. External network 172 may similarly be any suitable type of network.

From the perspective of drone operator 120, carrier operators 150 and/or carriers 152 may be analogous to network “security objects.” A security object may be any object that operates on or interacts with enterprise network 170 and that has actual or potential security implications. As with network security objects, carrier operator 150 and carrier 152 may have global or local reputations, and may have security designations.

Drone operator 120 may communicate across enterprise boundary 104 with external network 172. Enterprise boundary 104 may represent a physical, logical, or other boundary. External network 172 may include, for example, websites, servers, network protocols, and other network-based services. In one example, a security services provider 190 may provide services to secured enterprise 100.

Attacker 180 may also want to commit industrial or other espionage against drone operator 120, such as stealing goods, stealing classified or proprietary data, stealing identities, or gaining unauthorized access to enterprise resources.

Drone operator 120 may also contract with or subscribe to a security services provider 190, which may provide security services, updates, antivirus definitions, patches, products, and services. McAfee®, Inc. is a non-limiting example of such a security services provider that offers comprehensive security and antivirus solutions. In some cases, security services provider 190 may include a threat intelligence capability such as the global threat intelligence (GTI™) database provided by McAfee Inc. Security services provider 190 may update its threat intelligence database by analyzing new candidate malicious objects as they appear on client networks and characterizing them as malicious or benign.

In traditional practice, the McAfee GTI™ is used to assign reputations and security classifications to network objects. However, these methods may similarly be adapted to assign reputations and classifications to carriers 152 and/or carrier operators 150. For example, a timely and successful delivery may increase the operator's reputation. A delivery of the drone or its payload damaged may decrease its reputation. Other factors that may affect reputation may include tardiness, tampering with the payload, dangerous operation, user complaints, availability of desirable features (such as docking options or charging options), or other factors that affect the quality of a carrier's service.

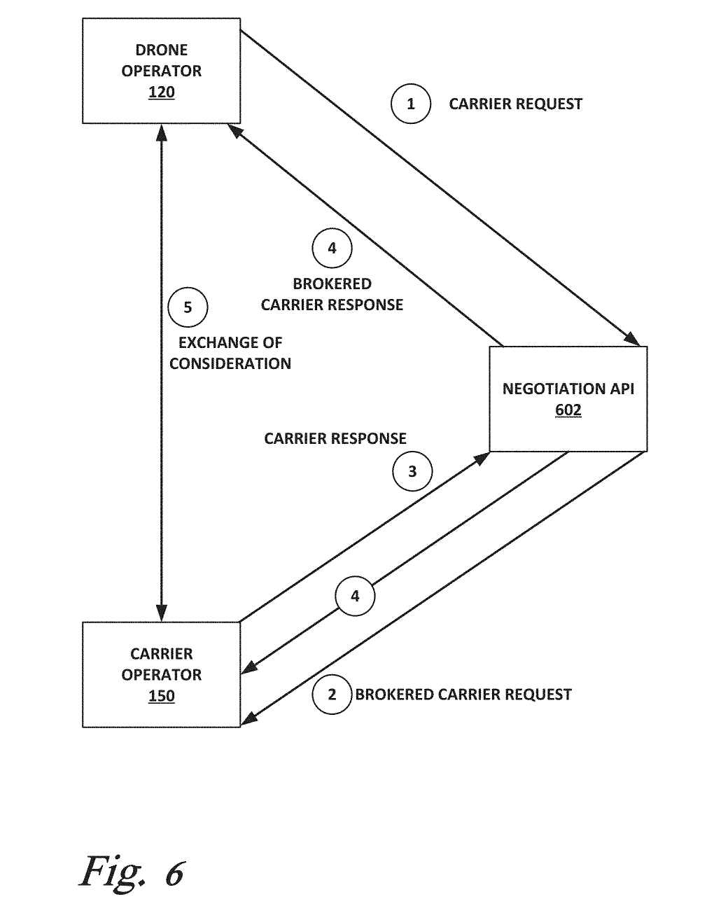

Note that although a single carrier operator 150 is shown in this illustration, in fact a plurality of carrier operators 150 may be provided. In the case of a plurality of carrier operators 150, broker service 142 may broker a request from drone operator 120 to select an appropriate carrier operator 150. Brokering of requests is discussed in detail in connection with FIG. 6. Once carrier operator 150 is selected for dispatch, carrier operator 150 dispatches carrier 152 to rendezvous with drone 124 and carry drone 124 through prohibitive zone 512. Drone 124 may then disengage from carrier 152 and negotiate its new route to customer 162, thus successfully delivering the product to customer 162.

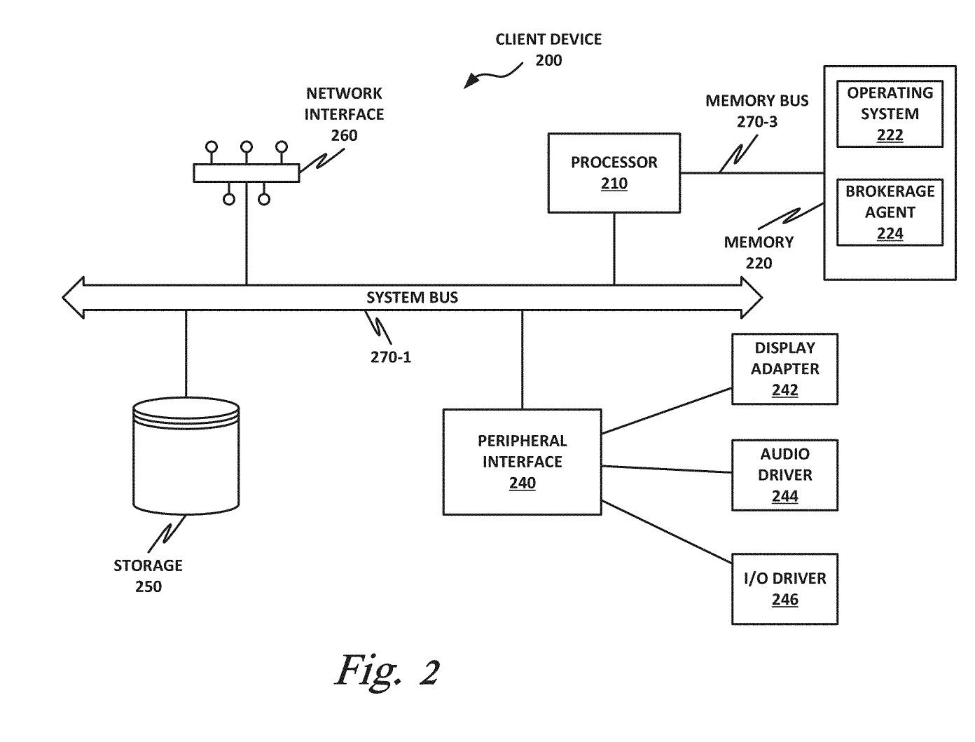

FIG. 2 is a block diagram of client device 200 according to one or more examples of the present specification. Client device 200 may be any suitable computing device. In various embodiments, a “computing device” may be or comprise, by way of non-limiting example, a computer, workstation, server, mainframe, virtual machine (whether emulated or on a “bare-metal” hypervisor), embedded computer, embedded controller, embedded sensor, personal digital assistant, laptop computer, cellular telephone, IP telephone, smart phone, tablet computer, convertible tablet computer, computing appliance, network appliance, receiver, wearable computer, handheld calculator, or any other electronic, microelectronic, or microelectromechanical device for processing and communicating data. Any computing device may be designated as a host on the network. Each computing device may refer to itself as a “local host,” while any computing device external to it may be designated as a “remote host.”

In certain embodiments, client devices 110 may all be examples of client devices 200.

Client device 200 includes a processor 210 connected to a memory 220, having stored therein executable instructions for providing an operating system 222 and at least software portions of a brokerage agent 224. Other components of client device 200 include a storage 250, network interface 260, and peripheral interface 240. This architecture is provided by way of example only, and is intended to be non-exclusive and non-limiting. Furthermore, the various parts disclosed are intended to be logical divisions only, and need not necessarily represent physically separate hardware and/or software components. Certain computing devices provide main memory 220 and storage 250, for example, in a single physical memory device, and in other cases, memory 220 and/or storage 250 are functionally distributed across many physical devices. In the case of virtual machines or hypervisors, all or part of a function may be provided in the form of software or firmware running over a virtualization layer to provide the disclosed logical function. In other examples, a device such as a network interface 260 may provide only the minimum hardware interfaces necessary to perform its logical operation, and may rely on a software driver to provide additional necessary logic. Thus, each logical block disclosed herein is broadly intended to include one or more logic elements configured and operable for providing the disclosed logical operation of that block. As used throughout this specification, “logic elements” may include hardware, external hardware (digital, analog, or mixed-signal), software, reciprocating software, services, drivers, interfaces, components, modules, algorithms, sensors, components, firmware, microcode, programmable logic, or objects that can coordinate to achieve a logical operation.

In an example, processor 210 is communicatively coupled to memory 220 via memory bus 270-3, which may be for example a direct memory access (DMA) bus by way of example, though other memory architectures are possible, including ones in which memory 220 communicates with processor 210 via system bus 270-1 or some other bus. Processor 210 may be communicatively coupled to other devices via a system bus 270-1. As used throughout this specification, a “bus” includes any wired or wireless interconnection line, network, connection, bundle, single bus, multiple buses, crossbar network, single-stage network, multistage network or other conduction medium operable to carry data, signals, or power between parts of a computing device, or between computing devices. It should be noted that these uses are disclosed by way of non-limiting example only, and that some embodiments may omit one or more of the foregoing buses, while others may employ additional or different buses.

In various examples, a “processor” may include any combination of logic elements operable to execute instructions, whether loaded from memory, or implemented directly in hardware, including by way of non-limiting example a microprocessor, digital signal processor, field-programmable gate array, graphics processing unit, programmable logic array, application-specific integrated circuit, or virtual machine processor. In certain architectures, a multi-core processor may be provided, in which case processor 210 may be treated as only one core of a multi-core processor, or may be treated as the entire multi-core processor, as appropriate. In some embodiments, one or more co-processor may also be provided for specialized or support functions.

Processor 210 may be connected to memory 220 in a DMA configuration via DMA bus 270-3. To simplify this disclosure, memory 220 is disclosed as a single logical block, but in a physical embodiment may include one or more blocks of any suitable volatile or non-volatile memory technology or technologies, including for example DDR RAM, SRAM, DRAM, cache, L1 or L2 memory, on-chip memory, registers, flash, ROM, optical media, virtual memory regions, magnetic or tape memory, or similar. In certain embodiments, memory 220 may comprise a relatively low-latency volatile main memory, while storage 250 may comprise a relatively higher-latency non-volatile memory. However, memory 220 and storage 250 need not be physically separate devices, and in some examples may represent simply a logical separation of function. It should also be noted that although DMA is disclosed by way of non-limiting example, DMA is not the only protocol consistent with this specification, and that other memory architectures are available.

Storage 250 may be any species of memory 220, or may be a separate device. Storage 250 may include one or more non-transitory computer-readable mediums, including by way of non-limiting example, a hard drive, solid-state drive, external storage, redundant array of independent disks (RAID), network-attached storage, optical storage, tape drive, backup system, cloud storage, or any combination of the foregoing. Storage 250 may be, or may include therein, a database or databases or data stored in other configurations, and may include a stored copy of operational software such as operating system 222 and software portions of brokerage agent 224. Many other configurations are also possible, and are intended to be encompassed within the broad scope of this specification.

Network interface 260 may be provided to communicatively couple client device 200 to a wired or wireless network. A “network,” as used throughout this specification, may include any communicative platform operable to exchange data or information within or between computing devices, including by way of non-limiting example, an ad-hoc local network, an internet architecture providing computing devices with the ability to electronically interact, a plain old telephone system (POTS), which computing devices could use to perform transactions in which they may be assisted by human operators or in which they may manually key data into a telephone or other suitable electronic equipment, any packet data network (PDN) offering a communications interface or exchange between any two nodes in a system, or any local area network (LAN), metropolitan area network (MAN), wide area network (WAN), wireless local area network (WLAN), virtual private network (VPN), intranet, or any other appropriate architecture or system that facilitates communications in a network or telephonic environment.

Brokerage agent 224, in one example, is operable to carry out computer-implemented methods as described in this specification. Brokerage agent 224 may include one or more tangible non-transitory computer-readable mediums having stored thereon executable instructions operable to instruct a processor to provide a brokerage agent 224. As used throughout this specification, an “engine” includes any combination of one or more logic elements, of similar or dissimilar species, operable for and configured to perform one or more methods provided by the engine. Thus, brokerage agent 224 may comprise one or more logic elements configured to provide methods as disclosed in this specification. In some cases, brokerage agent 224 may include a special integrated circuit designed to carry out a method or a part thereof, and may also include software instructions operable to instruct a processor to perform the method. In some cases, brokerage agent 224 may run as a “daemon” process. A “daemon” may include any program or series of executable instructions, whether implemented in hardware, software, firmware, or any combination thereof that runs as a background process, a terminate-and-stay-resident program, a service, system extension, control panel, bootup procedure, BIOS subroutine, or any similar program that operates without direct user interaction. In certain embodiments, daemon processes may run with elevated privileges in a “driver space” associated with ring 0, 1, or 2 in a protection ring architecture. It should also be noted that brokerage agent 224 may also include other hardware and software, including configuration files, registry entries, and interactive or user-mode software by way of non-limiting example.

In one example, brokerage agent 224 includes executable instructions stored on a non-transitory medium operable to perform a method according to this specification. At an appropriate time, such as upon booting client device 200 or upon a command from operating system 222 or a user, processor 210 may retrieve a copy of the instructions from storage 250 and load it into memory 220. Processor 210 may then iteratively execute the instructions of brokerage agent 224 to provide the desired method.

Brokerage agent 224 may be operated by drone operator 120 to request a carrier for drone 124 and to receive a brokered response that identifies a carrier 152. The brokered response may also include other information, such as a negotiated carrier rate, the carrier path, and carrier capabilities, by way of nonlimiting example. Drone operate 120 may then dispatch drone 124 to an engagement point. Note that while this example shows a brokerage agent 224 that is operated independently of drone 120, some or all of the functions of brokerage agent 224 could in fact be hosted on drone 120 itself.

Peripheral interface 240 may be configured to interface with any auxiliary device that connects to client device 200 but that is not necessarily a part of the core architecture of client device 200. A peripheral may be operable to provide extended functionality to client device 200, and may or may not be wholly dependent on client device 200. In some cases, a peripheral may be a computing device in its own right. Peripherals may include input and output devices such as displays, terminals, printers, keyboards, mice, modems, data ports (e.g., serial, parallel, USB, Firewire, or similar), network controllers, optical media, external storage, sensors, transducers, actuators, controllers, data acquisition buses, cameras, microphones, speakers, or external storage by way of non-limiting example.

In one example, peripherals include display adapter 242, audio driver 244, and input/output (I/O) driver 246. Display adapter 242 may be configured to provide a human-readable visual output, such as a command-line interface (CLI) or graphical desktop such as Microsoft Windows, Apple OSX desktop, or a Unix/Linux X Window System-based desktop. Display adapter 242 may provide output in any suitable format, such as a coaxial output, composite video, component video, VGA, or digital outputs such as DVI or HDMI, by way of nonlimiting example. In some examples, display adapter 242 may include a hardware graphics card, which may have its own memory and its own graphics processing unit (GPU). Audio driver 244 may provide an interface for audible sounds, and may include in some examples a hardware sound card. Sound output may be provided in analog (such as a 3.5 mm stereo jack), component (“RCA”) stereo, or in a digital audio format such as S/PDIF, AES3, AES47, HDMI, USB, Bluetooth or Wi-Fi audio, by way of non-limiting example.

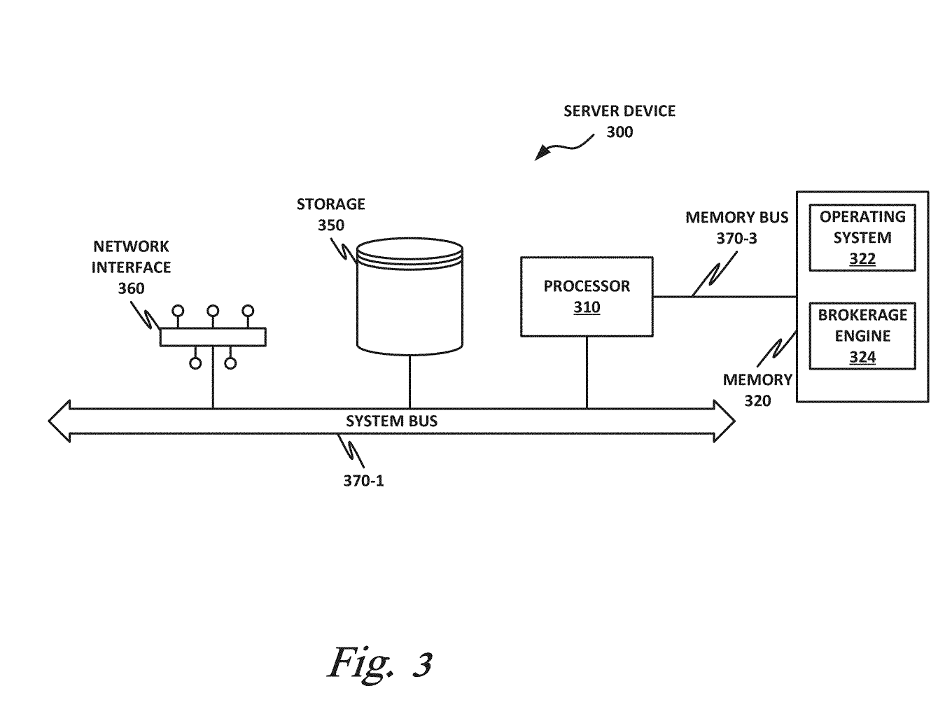

FIG. 3 is a block diagram of a server-class device 300 according to one or more examples of the present specification. Server 300 may be any suitable computing device, as described in connection with FIG. 2. In general, the definitions and examples of FIG. 2 may be considered as equally applicable to FIG. 3, unless specifically stated otherwise. Server 300 is described herein separately to illustrate that in certain embodiments, logical operations according to this specification may be divided along a client-server model, wherein client device 200 provides certain localized tasks, while server 300 provides certain other centralized tasks. In contemporary practice, server 300 is more likely than client device 200 to be provided as a “headless” VM running on a computing cluster, or as a standalone appliance, though these configurations are not required.

Server 300 includes a processor 310 connected to a memory 320, having stored therein executable instructions for providing an operating system 322 and at least software portions of a brokerage engine 324. Other components of server 300 include a storage 350, network interface 360, and peripheral interface 340. As described in FIG. 2, each logical block may be provided by one or more similar or dissimilar logic elements.

In an example, processor 310 is communicatively coupled to memory 320 via memory bus 370-3, which may be for example a direct memory access (DMA) bus. Processor 310 may be communicatively coupled to other devices via a system bus 370-1.

Processor 310 may be connected to memory 320 in a DMA configuration via DMA bus 370-3, or via any other suitable memory configuration. As discussed in FIG. 2, memory 320 may include one or more logic elements of any suitable type.

Storage 350 may be any species of memory 320, or may be a separate device, as described in connection with storage 250 of FIG. 2. Storage 350 may be, or may include therein, a database or databases or data stored in other configurations, and may include a stored copy of operational software such as operating system 322 and software portions of brokerage engine 324.

Network interface 360 may be provided to communicatively couple server 300 to a wired or wireless network, and may include one or more logic elements as described in FIG. 2.

Brokerage engine 324 is an engine as described in FIG. 2 and, in one example, includes one or more logic elements operable to carry out computer-implemented methods as described in this specification. Software portions of brokerage engine 324 may run as a daemon process.

Brokerage engine 324 may include one or more non-transitory computer-readable mediums having stored thereon executable instructions operable to instruct a processor to provide brokerage engine 324. At an appropriate time, such as upon booting server 300 or upon a command from operating system 322 or a user, processor 310 may retrieve a copy of brokerage engine 324 (or software portions thereof) from storage 350 and load it into memory 320. Processor 310 may then iteratively execute the instructions of brokerage engine 324 to provide the desired method.

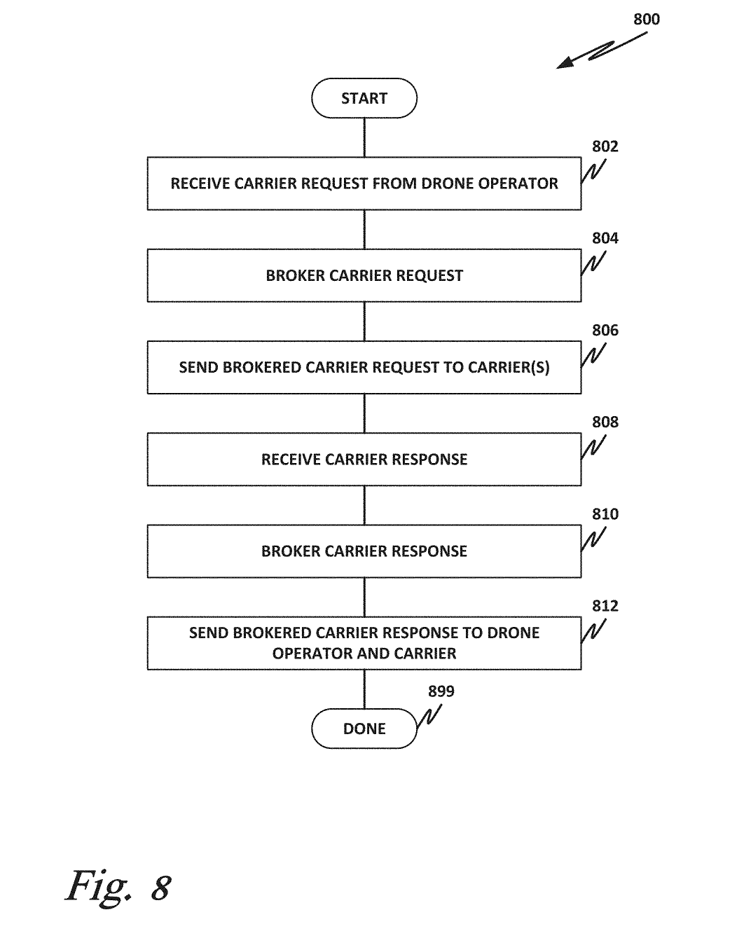

Brokerage engine 324 may be configured to provide brokering services between drone operator 120 and carrier operator 150. Such brokering services are disclosed in additional detail throughout this specification, such as in FIG. 6 and FIG. 8.

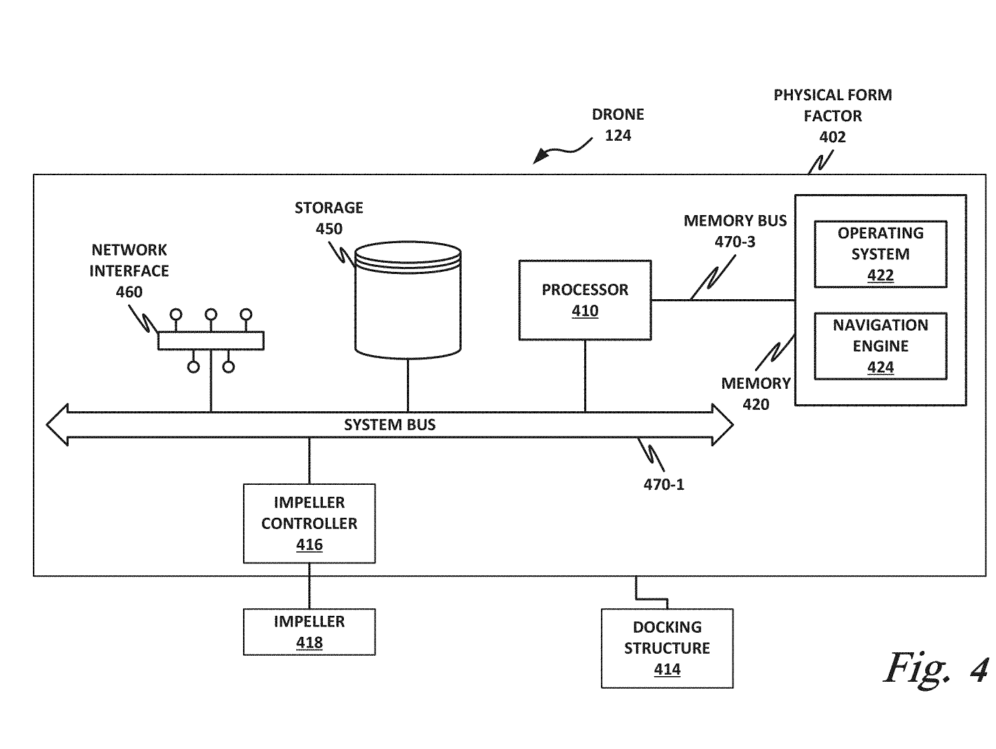

FIG. 4 is a block diagram of a drone 124 according to one or more examples of the present specification. Drone 124 may have both a physical form factor 402, which provides structure, and an internal computational engine, which may be any suitable computing device as described in FIG. 2. In general, the definitions and examples of FIG. 2 may be considered as equally applicable to FIG. 4, unless specifically stated otherwise.

Drone 124 includes a processor 410 connected to a memory 420, having stored therein executable instructions for providing an operating system 422 and at least software portions of a navigation engine 424. Other components of drone 124 include a storage 450, and network interface 460. As described in FIG. 2, each logical block may be provided by one or more similar or dissimilar logic elements.

In an example, processor 410 is communicatively coupled to memory 420 via memory bus 470-3, which may be for example a direct memory access (DMA) bus. Processor 410 may be communicatively coupled to other devices via a system bus 470-1.

Processor 410 may be connected to memory 420 in a DMA configuration via DMA bus 470-3, or via any other suitable memory configuration. As discussed in FIG. 2, memory 420 may include one or more logic elements of any suitable type.

Storage 450 may be any species of memory 420, or may be a separate device, as described in connection with storage 250 of FIG. 2. Storage 450 may be, or may include therein, a database or databases or data stored in other configurations, and may include a stored copy of operational software such as operating system 422 and software portions of navigation engine 424.

Network interface 460 may be provided to communicatively couple drone 124 to a wired or wireless network, and may include one or more logic elements as described in FIG. 2. In the case of drone 124, network interface 460 is likely to include at least one wireless network interface, to allow drone 124 to communicate with remote devices while in transit. This is not, however, an absolute requirement.

Navigation engine 424 is an engine as described in FIG. 2 and, in one example, includes one or more logic elements operable to carry out computer-implemented methods as described in this specification. Software portions of navigation engine 424 may run as a daemon process.

Navigation engine 424 may include one or more non-transitory computer-readable mediums having stored thereon executable instructions operable to instruct a processor to provide navigation engine 424. At an appropriate time, such as upon booting drone 124 or upon a command from operating system 422 or a user, processor 410 may retrieve a copy of navigation engine 424 (or software portions thereof) from storage 450 and load it into memory 420. Processor 410 may then iteratively execute the instructions of navigation engine 424 to provide the desired method.

Navigation engine 424 may be operable to direct drone 124 along the appropriate path, including causing drone 424 to proceed to an engage point, engage carrier 152, wait while the carrier carries the drone, then disengage at a disengage point. Navigation engine 424 may also compute a new path to proceed to its destination. In certain embodiments, navigation engine 424 may include, in addition to software, appropriate hardware devices such as a global positioning system (GPS), inertial navigation system, compass, or other hardware or software navigational aids.

Drone 124 includes an impeller 418, which may be any of the impellers discussed in the other patent. Impeller controller 416 interfaces with the physical impeller 418. An impeller should be understood to include any electrical, mechanical, electromechanical, or microelectromechanical agent, including any suitable combination of hardware and software, that can provide a motive force to a drone. In addition to electrically-powered propellers, an impeller may be or include a hydrocarbon fueled engine, chemical or nuclear engine or thruster, wheel and axle, tank tread, an electric motor, or any device that works on electrical or magnetic field principles, by way of nonlimiting example. In one example, a waterborne drone may include a water pump to provide thrust. In another example, a small magneto hydrodynamic impeller, which uses magnetic fields to propel water through a tube, may provide motion. In another example, a propeller may be used to impel nodes through either air or water. In a vacuum, a rocket impeller may be used. In cases where a drone is to run along a surface, a wheel and axle, along with a suitable drivetrain may be used. Depending on the type of drone, the impeller may be very large or very small, and may be fueled by any suitable fuel source.

Where it is provided, docking structure 414 may enable drone 124 to securely dock, such as to carrier 152. Note that in some examples, it is sufficient for drone 124 to land on carrier 152. In other cases, drone 124 may land so that an operator of carrier 152 may place drone 124 in a secure compartment, such as the passenger compartment of a car. The operator may then release drone 124 at the disengage point. In other examples, magnets, suction cups, or interlocking docking structures may be provided by way of nonlimiting example. Docking structure 414 may also include a charging interface, so that carrier drone 124 can charge while riding on carrier 152. In other embodiments, a charging structure may be provided separate from docking structure 414.

In certain embodiments, client device 110, drone 124, and/or carrier operator 150 may provide a trusted execution environment (TEE) for secure computing and communication. A memory enclave is a specially-designated portion of memory that cannot be entered into or exited from except via special instructions, such as Intel® SGX or similar. An enclave is provided as an example of a secure environment which, in conjunction with a secure processing engine, forms a trusted execution environment (TEE). A TEE is a combination of hardware, software, and/or memory allocation that provides the ability to securely execute instructions without interference from outside processes, in a verifiable way. Non-limiting examples of solutions that either are or that can provide a TEE include Intel® SGX, ARM TrustZone, AMD Platform Security Processor, Kinibi, securiTEE, OP-TEE, TLK, T6, Open TEE, SierraTEE, CSE, VT-x, MemCore, Canary Island, Docker, and Smack.

In certain systems, computing devices equipped with the Intel® Software Guard Extension (SGX™) or equivalent instructions may be capable of providing an enclave. It should be noted however, that many other examples of TEEs are available.

In an example, the enclave provides a protected memory area that cannot be accessed or manipulated by ordinary computer instructions. One feature of an enclave is that once an enclave region of memory is defined, a program pointer cannot enter or exit the enclave without the use of special enclave instructions or directives, such as those provided by Intel® SGX architecture. For example, SGX processors provide the ENCLU[EENTER], ENCLU[ERESUME], and ENCLU[EEXIT]. These are the only instructions that may legitimately enter into or exit from the enclave.

FIG. 5 is a diagram of a drone route according to one or more examples of the present specification. In this example, drone 124 is dispatched by drone operator 120 and starts at origin 502. Theoretically, drone 124 should follow original path 506 as the shortest (or otherwise optimal) route from origin 502 to destination 504.

But original path 506 passes through prohibitive zone 512. Prohibitive zone 512 is an area where it is impractical, illegal, or impossible for drone 124 to pass through. A prohibitive zone may be delineated many different factors. For example, one prohibitive zone may include a long stretch that is simply out of range for the drone. Another prohibitive zone may include a no-fly zone where it is illegal for the drone to operate. Yet another prohibitive zone may be a bridge where it is impractical or illegal for the drone to navigate. Yet another prohibitive zone may include a crowded metropolitan area, where navigation obstacles make it impractical for the drone to navigate. Yet another example of a prohibitive zone is a zone where it is unsafe for drones to operate (even if it legal and otherwise practical for the drone), such as areas experiencing strong weather patterns, strong electrical magnetic or electrical fields that may interfere with navigation, or where irritable land owners are liable to simply shoot drones out of the sky.

Note that in some embodiments, prohibitive zone 512 may not be identified a priori. Rather, drone 124 may encounter circumstances en route (i.e., along original path 506) that create or define a prohibitive zone. To provide just one illustrative example, while traveling along its intended path, drone 124 may encounter strong head winds that exhaust its fuel or energy supply more quickly than anticipated. In that case, drone 124 may determine that it has insufficient fuel remaining to reach its destination. In that case, drone 124 may contact drone operator 120 to request a carrier. Drone operator 120 may then negotiate a carrier, and upload new path instructions to drone 124.

For any of the foregoing reasons, or for any other suitable reason, drone 124 may not be able to follow the original path 506 to destination 504. Rather, drone operator 120 operates brokerage agent 224 to broker a carrier via broker service 142. Once the carrier is brokered, carrier operator 150 dispatches carrier 152 to engage point 514. Note that in this illustration, engage point 514 lies along original path 506. But this need not always be the case. Engage point 514 may be any point within range of drone 124.

Carrier 152 engages with drone 124 at engage point 514 and follows carrier path 510 through prohibitive zone 512. Carrier path 510 may be a road or other path that a carrier 152 may follow. Note that carrier 152 need not be a car or truck. It could be an airplane, a ship, a train, a submarine, or any other vehicle or object that is capable of carrying drone 124. Carrier 152 carries drone 124 through prohibitive zone 512 via carrier path 510. Once carrier 152 reaches disengage point 516, drone 124 disengages from carrier 152 and follows modified path 508 to destination 504.

Note that in this case, a single carrier 152 is shown by illustrative example. However, in some embodiments, drone 124 may hop from a disengage point to a new engage point and engage another carrier 152. Thus, multiple carriers may cooperate to carry drone 124 through prohibitive zone 512, and following modified path 508 to destination 504 may in fact comprise engaging a second (or third, or more) carrier. Thus, in some examples, disengage point 516 may be within prohibitive zone, and additional carriers 152 may be required to take drone 124 out of prohibitive zone 512.

Engaging and disengaging with carrier 152 may be accomplished via any suitable means. In one example, drone 124 may simply land on the roof of a vehicle. If drone 124 has sufficient ability or has a suitable docking structure 414, this may be sufficient. For example, docking structure 414 made comprise electromagnets or mechanically actuated suction cups that securely affix drone 124 to the roof of carrier 152. In other examples, docking structure 414 may be a more complicated interlocking structure, with a complementary interlocking structure on carrier 152. In yet another example, drone 124 proceeds to engage point 514, at which point carrier operator 150 simply picks drone 124 up and places the drone in the vehicle. When carrier operator 150 reaches disengage point 516, the operator may then simply place to drone on the ground to releases drone 124. Drone 124 may then proceed via modified path 508 to destination 504. In other cases, drone 124 may lack a specific docking structure 414, and carrier 152 may accommodate drone 124 by providing a secure docking structure, such as an enclosed or semi enclosed hatch on the roof of carrier 152 in which drone 124 can land and then be protected from wind and other elements. If carrier 152 is a train, then an open train car may provide a docking opportunity. If carrier 152 is a ship, then docking may include landing on a deck. Many other combinations and configurations are possible, and are intended to be included within the scope of “docking” and “undocking” as used in this specification.

In this illustration, prohibitive zone 512 is shown as a well-defined zone with definite boundaries, but this is a non-limiting example. Particularly in the case of destination 504 being out of range of drone 124, the boundaries of prohibitive zone 512 may be flexible. In that case, prohibitive zone 512 may initially include the entire universe outside of a radius defined by the range of drone 124. As long as destination 504 is within that original prohibitive zone, a carrier may be needed. However, once a carrier's services have been brokered, the boundaries of prohibitive zone 512 may conceptually be redefined. Specifically, the new prohibitive zone 512 may be defined as a transit region that would prevent drone 124 from reaching destination 504 if drone 124 were to cross the entire prohibitive zone 512. Stated differently, drone 124 may be capable of reaching the new prohibitive zone 512, and indeed of completely traversing prohibitive zone 512, but in doing so, drone 124 exhausts its ability to reach destination 504 from disengage point 516. So in this case, or in any similar example, prohibitive zone 512 is a zone that does not strictly prohibit drone 124 from operating, but rather is a zone that prevents drone 124 from completing its intended mission. In such cases, the boundaries of prohibitive zone may be usefully defined as starting at or around engage point 514, and to end at or around disengage point 516.

FIG. 6 is a signal flow diagram illustrating the passage of signals according to an embodiment of the present specification. In this example, brokerage engine 324 provides a negotiation API 602 that both drone operator 120 and carrier operator 150 are able to access.

At operation 1, drone operator 120 dispatches a carrier request to negotiation API 602. Negotiation API 602 receives carrier request 1 and brokers carrier requests 1 within brokerage engine 324. Negotiation API 602 then sends brokered carrier request 2 to one or more carrier operators 150. The process of brokering a carrier request is discussed in additional detail in connection with FIG. 8.

Carrier operator 150 receives brokered carrier request 2 and sends a carrier response 3 to negotiation API 602. Negotiation API 602 receives carrier response 3 and brokers carrier response 3 within brokerage engine 324. The process of brokering carrier response 3 is discussed in additional detail in connection with FIG. 8.

Negotiation API 602 then sends brokered carrier response 4 to both drone operator 120 and carrier operator 150. This informs both that carrier operator 150 has been selected to fulfill carrier request 1 from drone operator 120.

Finally, at operation 5 drone operator 120 and carrier operator 150 exchange consideration. This may be a direct exchange of consideration, or consideration may be exchanged via negotiation API 602. In other embodiments, consideration may be exchanged via a third-party operator, such as PayPal or similar. Consideration is used in this context according to its broadest legal interpretation, to include fiscal remuneration, exchange of goods or services, or any other mutually reciprocal inducement. In accordance with embodiments disclosed herein, at least part of the consideration provided by carrier operator 150 is the availability of carrier 152 to carry drone 124 through prohibitive zone 512. However, that need not be the total consideration provided by carrier operator 150. According to embodiments disclosed herein, drone operator 120 provides fiscal remuneration to carrier operator 150. But again, the consideration need not include money, and need not be limited to the exchange of money.

Note that in certain embodiments, carrier operator 150 may be a ridesharing service such as Lyft or Uber. In that case, broker service 142 may find a carrier 152 that is passing through prohibitive zone 512 and broker a ride for drone 124 on carrier 152. In another example, for a premium delivery fee, drone operator 120 may allow customer 162 to request highly expedited delivery, in which case drone operator 120 may engage rideshare service carrier operator 150 directly to carry drone 124 to a disengage point. In this context, carrier 152 is acting similar to a courier service that engages drone 124, couriers drone 124 to a disengage point 516, and then disengages drone 124. In that case, drone 124 may act as the actual “rider” for the ridesharing service. Many other embodiments are possible.

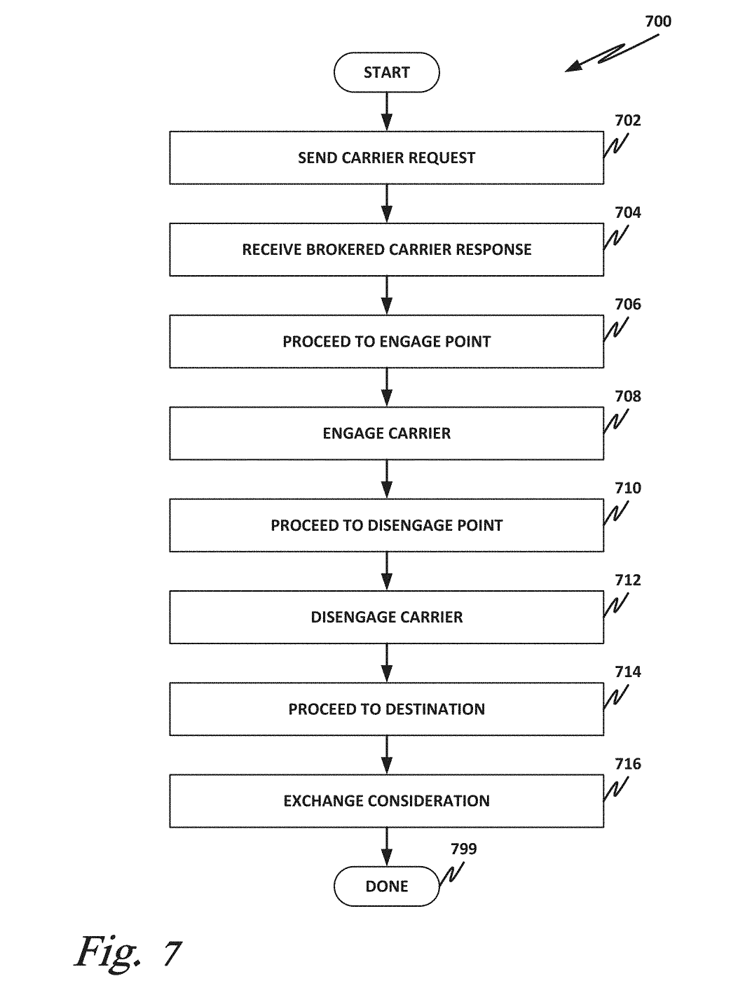

FIG. 7 is a flowchart of a method 700 performed by brokerage agent 224 according to one or more examples of the present specification.

In block 702, drone operator 120 sends a carrier request to broker service 142 via brokerage agent 224. Carrier request 702 may include information such as the type and dimensions of prohibitive zone 512, a desired carrier path 510, and selection options such as a preferred carrier operator 150, preferred carrier 152, or a preferred type of carrier, a minimum and/or maximum price point, and other factors that may enable broker service 142 to select from between a plurality of carrier operators 150 and carriers 152.

In block 704, brokerage agent 224 waits until broker service 142 provides a brokered carrier response. Upon receiving brokered carrier response, drone operator 120 may dispatch drone 124 to engage point 514. Optionally drone operator 120 may reject the suggested carrier operator 150 or carrier 152, in which case the negotiation may be restarted.

Once a carrier 152 has been successfully selected and negotiated, drone operator 120 dispatches drone 124 to engage point 514. At engage point 514, drone 124 engages carrier 152.

In block 710, drone 124 is carried to disengage point 516 by a carrier 152 via carrier path 510.

In block 712, having successfully arrived at disengage point 516, drone 124 disengages from carrier 152.

In block 714, drone 124 proceeds to destination 504 via modified path 508.

In block 716, drone operator 120 exchanges consideration with carrier operator 150, such as providing a payment to carrier operator 150.

In block 799, the method is done.

FIG. 8 is a flowchart of a method 800 performed by brokerage engine 324 according to one or more embodiments of the present specification.

In block 802, brokerage engine 324 receives from brokerage agent 224 a carrier requests for drone operator 120.

In block 804, brokerage engine 324 brokers the carrier request. Brokering a carrier request may include scanning a database of available carrier operators 150, which may include posted schedules of availability or routes. For example, a ride share service may get a request from a rider to go from point A to point B. The ride share service may post this request via negotiation API 602 so that brokerage engine 324 knows that a rider will be traveling that route. Brokerage engine 324 may then match that route to one or more carrier requests from one or more drone operators 120. Ride sharing routes are just one example of information that may be posted to negotiation API 602. Other examples include bus or train schedules, shipping routes and/or manifests, aircraft routes and/or manifests, or vehicles available for charter, by way of non-limiting example. In one example, the carrier could even be a trained or migrating animal or herd, in which case posted information may include migratory habits or trained routes.

Brokerage engine 324 may select a suitable carrier operator 150 according to criteria specified by drone operator 120 in the carrier request of block 802. This may include options such as a proposed route, preferred route, a size, dimensions, or location of prohibitive zone 512, a preferred individual carrier 152, a preferred type of carrier 152, or other data that enables brokerage engine 324 to select a carrier operator 150.

In one example, a plurality of carrier operators 150 are provided, and broker service 142 contracts security services provider 190 to provide not only security, but also reputations for carrier operators 150 and carriers 152. These reputations may be similar to the reputations of network objects such as those provided for anti-malware programs. A reputation may be modified each time a carrier operator 150 dispatches a carrier 152 to carry a drone 124. The reputation of the carrier and carrier operator may be affected by factors such as the expediency of pickup, timeliness of pickup, the availability of drone docking options, the effective range of carrier 152, the ability of carrier 152 to deliver goods and drone 124 undamaged, and their reputation for not tampering with the payload of drone 124, by way of nonlimiting example. The reputation of carrier operator 150 or carrier 152 may then be used as part of the brokering process to select a best carrier for the carrier request of block 802.

In some examples, a carrier request may include a requirement that a carrier operator 150 or carrier 152 have a particular minimum reputation before it is allowed to handle the cargo. In some cases, use of a carrier with a high reputation, or a requirement that a carrier have a higher reputation, may come at a premium price. In some cases, selection of a carrier operator 150 or carrier 152 without regard to reputation, or with a lower reputation threshold, may cost less. Thus, in certain embodiments, drone operator 120 and carrier operator 150 do not directly negotiate, and either or both may not be entitled to demand a particular price point. Rather, broker engine 324 may broker a price within an acceptable range for both, which may include one or more price premium factors. Prices may also be affected by factors such as current demand, priority queuing, custom routes, or diversion of carrier 152 from its optimal route, by way of nonlimiting example.

In block 806, once brokerage engine 324 has brokered the carrier request, it sends the brokered carriers request to one or more carrier operators 150 that are able to service the request.

In block 808, brokerage engine 324 receives one or more carrier responses from one or more carrier operators 150. These carrier responses may include information such as a minimum acceptable price, a time of availability, available carriers 152, and metadata about available carriers.

In block 810, brokerage engine 324 brokers the one or more carrier responses. This is similar to brokering a request, and may include many similar factors or counter-factors (e.g., maximum price vs. minimum price, best available reputation vs. minimum requested reputation, etc.) This may include selecting a best carrier response according to an algorithm that may include factors such as the most timely responsive carrier operator 150, the operator with the best reputation, the operator with the best available price for this trip, or other factors that may influence the selection of a carrier.

In block 812, brokerage engine 324 sends the brokered carrier response to both drone operator 120 and carrier operator 150. This informs carrier operator 150 that it has been selected to service a request, and informs drone operator 120 of which carrier has been elected to service the request. Note that in some embodiments, brokerage engine 324 may not send the brokered carrier response to carrier operator 150 until drone operator 120 has confirmed the arrangement. In other embodiments, drone operator 120's conveyance of a carrier request may be contractually sufficient to obligate drone operator 120 to accept the brokered carrier. The brokered carrier response may also include information such as the time and place of engage point 514, the time and place of disengage point 516, the brokered price, the method of engagement and disengagement, and any other information that may be required to for drone operator 120 and carrier operator 150 to successfully perform the carrier function and exchange consideration.

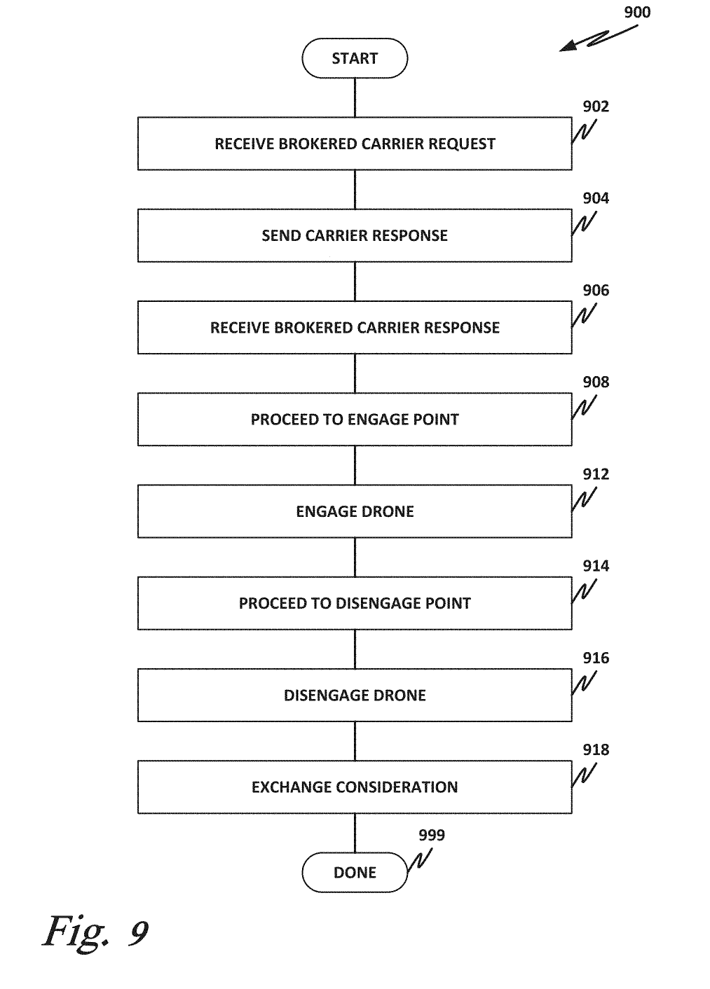

FIG. 9 is a flowchart of a method 900 performed by a brokerage agent 224 operated by carrier operator 150 according to one or more examples of the present specification.

In block 902, carrier operator 150 receives a brokered carrier request.

In block 904, carrier operator 150 sends a carrier response to broker service 142. This may include information such as available carriers 152, a proposed minimum price, a proposed carrier half 510, types of carriers available, and any other information that may be useful in allowing brokerage service 142 to select an appropriate carrier.

In block 906, carrier operator 150 receives a brokered carrier response, which may indicate to carrier operator 150 that has been selected to service the request, and may include information such as a brokered price, an engage point 514, a carrier path 510, a disengage point 516, and any other information that carrier 150 needs to successfully allow carrier 152 to receive drone 124 at engage point 514, successfully navigate carrier path 510, and disengage drone 124 at disengage point 516.

In block 908, carrier operator 150 dispatches carrier 152, which proceeds to engage point 514.

In block 912, carriers 152 engages drone 124.

In block 914, carrier 152 conveys drone 124 along carrier path 510 to disengage point 516.

In block 916, carrier 152 disengage is drone 124.

In block 918, carrier operator 150 exchanges consideration with drone operator 120.

In block 999, the method is done.

The foregoing outlines features of several embodiments so that those skilled in the art may better understand various aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

All or part of any hardware element disclosed herein may readily be provided in a system-on-a-chip (SoC), including central processing unit (CPU) package. An SoC represents an integrated circuit (IC) that integrates components of a computer or other electronic system into a single chip. Thus, for example, client devices 110 or server devices 300 may be provided, in whole or in part, in an SoC. The SoC may contain digital, analog, mixed-signal, and radio frequency functions, all of which may be provided on a single chip substrate. Other embodiments may include a multi-chip-module (MCM), with a plurality of chips located within a single electronic package and configured to interact closely with each other through the electronic package. In various other embodiments, the computing functionalities disclosed herein may be implemented in one or more silicon cores in Application Specific Integrated Circuits (ASICs), Field Programmable Gate Arrays (FPGAs), and other semiconductor chips.

Note also that in certain embodiment, some of the components may be omitted or consolidated. In a general sense, the arrangements depicted in the figures may be more logical in their representations, whereas a physical architecture may include various permutations, combinations, and/or hybrids of these elements. It is imperative to note that countless possible design configurations can be used to achieve the operational objectives outlined herein. Accordingly, the associated infrastructure has a myriad of substitute arrangements, design choices, device possibilities, hardware configurations, software implementations, and equipment options.

In a general sense, any suitably-configured processor, such as processor 210, can execute any type of instructions associated with the data to achieve the operations detailed herein. Any processor disclosed herein could transform an element or an article (for example, data) from one state or thing to another state or thing. In another example, some activities outlined herein may be implemented with fixed logic or programmable logic (for example, software and/or computer instructions executed by a processor) and the elements identified herein could be some type of a programmable processor, programmable digital logic (for example, a field programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof.

In operation, a storage such as storage 250 may store information in any suitable type of tangible, non-transitory storage medium (for example, random access memory (RAM), read only memory (ROM), field programmable gate array (FPGA), erasable programmable read only memory (EPROM), electrically erasable programmable ROM (EEPROM), etc.), software, hardware (for example, processor instructions or microcode), or in any other suitable component, device, element, or object where appropriate and based on particular needs. Furthermore, the information being tracked, sent, received, or stored in a processor could be provided in any database, register, table, cache, queue, control list, or storage structure, based on particular needs and implementations, all of which could be referenced in any suitable timeframe. Any of the memory or storage elements disclosed herein, such as memory 220 and storage 250, should be construed as being encompassed within the broad terms ‘memory’ and ‘storage,’ as appropriate. A non-transitory storage medium herein is expressly intended to include any non-transitory special-purpose or programmable hardware configured to provide the disclosed operations, or to cause a processor such as processor 210 to perform the disclosed operations.

Computer program logic implementing all or part of the functionality described herein is embodied in various forms, including, but in no way limited to, a source code form, a computer executable form, machine instructions or microcode, programmable hardware, and various intermediate forms (for example, forms generated by an assembler, compiler, linker, or locator). In an example, source code includes a series of computer program instructions implemented in various programming languages, such as an object code, an assembly language, or a high-level language such as OpenCL, FORTRAN, C, C++, JAVA, or HTML for use with various operating systems or operating environments, or in hardware description languages such as Spice, Verilog, and VHDL. The source code may define and use various data structures and communication messages. The source code may be in a computer executable form (e.g., via an interpreter), or the source code may be converted (e.g., via a translator, assembler, or compiler) into a computer executable form, or converted to an intermediate form such as byte code. Where appropriate, any of the foregoing may be used to build or describe appropriate discrete or integrated circuits, whether sequential, combinatorial, state machines, or otherwise.

In one example embodiment, any number of electrical circuits of the FIGURES may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processor and memory can be suitably coupled to the board based on particular configuration needs, processing demands, and computing designs. Other components such as external storage, additional sensors, controllers for audio/video display, and peripheral devices may be attached to the board as plug-in cards, via cables, or integrated into the board itself. In another example, the electrical circuits of the FIGURES may be implemented as stand-alone modules (e.g., a device with associated components and circuitry configured to perform a specific application or function) or implemented as plug-in modules into application specific hardware of electronic devices.

Note that with the numerous examples provided herein, interaction may be described in terms of two, three, four, or more electrical components. However, this has been done for purposes of clarity and example only. It should be appreciated that the system can be consolidated or reconfigured in any suitable manner. Along similar design alternatives, any of the illustrated components, modules, and elements of the FIGURES may be combined in various possible configurations, all of which are within the broad scope of this specification. In certain cases, it may be easier to describe one or more of the functionalities of a given set of flows by only referencing a limited number of electrical elements. It should be appreciated that the electrical circuits of the FIGURES and its teachings are readily scalable and can accommodate a large number of components, as well as more complicated/sophisticated arrangements and configurations. Accordingly, the examples provided should not limit the scope or inhibit the broad teachings of the electrical circuits as potentially applied to a myriad of other architectures.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 (pre-AIA) or paragraph (f) of the same section (post-AIA), as it exists on the date of the filing hereof unless the words “means for” or “steps for” are specifically used in the particular claims; and (b) does not intend, by any statement in the specification, to limit this disclosure in any way that is not otherwise expressly reflected in the appended claims.

### Example Implementations

There is disclosed in one example, a computing apparatus comprising: a network interface; and one or more logic elements, including at least a processor and a memory, comprising a broker agent to: communicatively couple to a drone brokerage engine via the network interface; send a carrier request comprising a request for a carrier to carry a drone through a prohibitive zone; receive a brokered carrier response comprising an engage point; and dispatch the drone to the engage point.

There is further disclosed an example, wherein the carrier request comprises a request for a carrier separately engaged to pass through the prohibitive zone.

There is further disclosed an example, wherein the carrier request comprises a request to specially engage a carrier to pass through the prohibitive zone.

There is further disclosed an example, wherein the carrier request comprises a request to wait for a third party to engage the carrier pass through the prohibitive zone.

There is further disclosed an example, wherein the carrier request comprises a request for manual stowage of the drone.

There is further disclosed an example, wherein the carrier request comprises a request that the carrier provide dock-and-charge capability.

There is further disclosed an example, wherein the carrier request comprises a request that the carrier provide drone-navigable docking capability.

There is further disclosed an example of a drone, comprising: an impeller; and one or more logic elements, including at least one hardware logic element, comprising a navigation engine to: receive a dispatch message, including an engage point outside of a prohibitive zone; navigate the drone to the engage point; and engage a carrier at the engage point.

There is further disclosed an example, wherein the navigation engine is further to: wait for the carrier to pass through the prohibitive zone; and disengage from the carrier.

There is further disclosed an example, wherein disengaging from the carrier comprises waiting for an operator of the carrier to remove the drone from a stowage, and proceeding.

There is further disclosed an example, wherein disengaging from the carrier comprises disengaging a charging coupling.

There is further disclosed an example, wherein disengaging from the carrier comprises disengaging a drone-navigable coupling.

There is further disclosed an example, wherein engaging the carrier comprises landing and waiting for manual stowage.

There is further disclosed an example, wherein engaging the carrier comprises engaging a charging coupling.

There is further disclosed an example, wherein engaging the carrier comprises engaging a drone-navigable coupling.

There is further disclosed an example, wherein the navigation engine is further to: receive a modified path to a destination; and operate the impeller to move the drone to the destination.

There is further disclosed an example of a computing apparatus comprising: a network interface; and one or more logic elements, including at least one hardware logic element, comprising a drone brokerage engine to: receive a carrier request from a drone operator, the carrier request comprising a request to carry a drone through a prohibitive zone; broker the carrier request; send the brokered carrier request to at least one carrier operator; receive a carrier response; broker the carrier response; and send the brokered carrier response to the drone operator.

There is further disclosed an example, wherein the drone brokerage engine is further to publish carrier routing information to the drone operator.

There is further disclosed an example, wherein the carrier request comprises drone specification data, and brokering the carrier request comprises matching the drone specification data to one or more carriers.

There is further disclosed an example, wherein the drone specification data comprises a mass of the drone plus a payload.

There is further disclosed an example, wherein the drone specification data comprises a docking capability of the drone.

There is further disclosed an example, the drone specification data comprises a charger coupling capability of the drone.

There is further disclosed an example, wherein the drone specification data comprises drone capabilities.

There is further disclosed an example, wherein the drone specification comprises drone type.

There is further disclosed an example, wherein the carrier request comprises a preferred price range, and wherein brokering the carrier request comprises matching the preferred price range to price ranges of one or more carriers.

There is further disclosed an example of one or more tangible, non-transitory computer-readable storage mediums having stored thereon executable instructions for instructing one or more processors for providing an engine operable for performing any or all of the operations of the preceding examples.

There is further disclosed an example of a method of providing an engine comprising performing any or all of the operations of the preceding examples.

There is further disclosed an example of an apparatus comprising means for performing the method.

There is further disclosed an example wherein the means comprise a processor and a memory.

There is further disclosed an example wherein the means comprise one or more tangible, non-transitory computer-readable storage mediums.

There is further disclosed an example wherein the apparatus is a computing device.

What is claimed is:

1. A computing apparatus comprising:
a network interface; and
one or more logic elements, including at least a processor and a memory, comprising a broker agent to:
communicatively couple to a drone brokerage engine via the network interface;
send a carrier request comprising a request for a carrier to carry a drone through a prohibitive zone;
receive a brokered carrier response comprising an engage point; and
dispatch the drone to the engage point.

2. The computing apparatus of claim 1, wherein the carrier request comprises a request for a carrier separately engaged to pass through the prohibitive zone.

3. The computing apparatus of claim 1, wherein the carrier request comprises a request to specially engage a carrier to pass through the prohibitive zone.

4. The computing apparatus of claim 1, wherein the carrier request comprises a request to wait for a third party to engage the carrier pass through the prohibitive zone.

5. The computing apparatus of claim 1, wherein the carrier request comprises a request for manual stowage of the drone.

6. The computing apparatus of claim 1, wherein the carrier request comprises a request that the carrier provide dock-and-charge capability.

7. The computing apparatus of claim 1, wherein the carrier request comprises a request that the carrier provide drone-navigable docking capability.

8. A drone, comprising:
an impeller; and
one or more logic elements, including at least one hardware logic element, comprising a navigation engine to:
receive a dispatch message, including an engage point outside of a prohibitive zone;
navigate the drone to the engage point; and
engage a carrier at the engage point.

9. The drone of claim 8, wherein the navigation engine is further to:
wait for the carrier to pass through the prohibitive zone; and
disengage from the carrier.

10. The drone of claim 9, wherein disengaging from the carrier comprises waiting for an operator of the carrier to remove the drone from a stowage, and proceeding.

11. The drone of claim 9, wherein disengaging from the carrier comprises disengaging a charging coupling.

12. The drone of claim 9, wherein disengaging from the carrier comprises disengaging a drone-navigable coupling.

13. The drone of claim 8, wherein engaging the carrier comprises landing and waiting for manual stowage.

14. The drone of claim 8, wherein engaging the carrier comprises engaging a charging coupling.

15. The drone of claim 8, wherein engaging the carrier comprises engaging a drone-navigable coupling.

16. The drone of claim 8, wherein the navigation engine is further to:
receive a modified path to a destination; and
operate the impeller to move the drone to the destination.

17. A computing apparatus comprising:
a network interface; and
one or more logic elements, including at least one hardware logic element, comprising a drone brokerage engine to:
receive a carrier request from a drone operator, the carrier request comprising a request to carry a drone through a prohibitive zone;
broker the carrier request;
send the brokered carrier request to at least one carrier operator;
receive a carrier response;
broker the carrier response; and
send the brokered carrier response to the drone operator.

18. The computing apparatus of claim 17, wherein the drone brokerage engine is further to publish carrier routing information to the drone operator.

19. The computing apparatus of claim 17, wherein the carrier request comprises drone specification data, and brokering the carrier request comprises matching the drone specification data to one or more carriers.

20. The computing apparatus of claim 19, wherein the drone specification data comprises a mass of the drone plus a payload.

21. The computing apparatus of claim 19, wherein the drone specification data comprises a docking capability of the drone.

22. The computing apparatus of claim 19, the drone specification data comprises a charger coupling capability of the drone.

23. The computing apparatus of claim 17, wherein the drone specification data comprises drone capabilities.

24. The computing apparatus of claim 17, wherein the drone specification comprises drone type.

25. The computing apparatus of claim 17, wherein the carrier request comprises a preferred price range, and wherein brokering the carrier request comprises matching the preferred price range to price ranges of one or more carriers.
